(19) United States
(12) Patent Application Publication
(10) Pub. No.: US 2026/0270776 A1
(43) Pub. Date: Sep. 10, 2026

(54) WIRELESS SYSTEMS WITH CONTROL LOGIC FOR DYNAMIC ADAPTATION OF WIFI PARAMETERS FOR NETWORK CONGESTION MANAGEMENT

(71) Applicant: GM GLOBAL TECHNOLOGY OPERATIONS LLC, Detroit, MI (US)

(72) Inventors: Haneya Qureshi, Troy, MI (US); Azin Neishaboori, Plymouth, MI (US); Lakshmi V. Thanayankizil, Rochester Hills, MI (US); John Sergakis, Bloomfield Hills, MI (US)

(73) Assignee: GM GLOBAL TECHNOLOGY OPERATIONS LLC, Detroit, MI (US)

(21) Appl. No.: 19/070,722

(22) Filed: Mar. 5, 2025

(51) Int. Cl. H04W 28/02; H04L 43/0876; H04W 24/02

(52) U.S. Cl. CPC H04W 28/0289; H04L 43/0876; H04W 24/02

(57) ABSTRACT

Presented are wireless communication systems that dynamically adapt system parameters to manage network congestion, methods for making/using such systems, and vehicles equipped with such systems. A method of operating a wireless communication system includes a system controller monitoring various network traffic factors that affect network congestion to generate raw network traffic data, and using a trained machine-learning model to transform the raw network traffic data based on a processing rule set to generate processed traffic data. The system controller calculates a congestion score as a function of traffic factor values within the processed traffic data, each of which is weighted using a respective weight factor assigned to the corresponding traffic factor within the network traffic factors. Responsive to a determination that the congestion score exceeds a congestion threshold value, the system controller modulates operation of the wireless communication system by adjusting multiple system WiFi parameters based on the congestion score.

### INTRODUCTION

The present disclosure relates generally to wireless communication systems. More specifically, aspects of this disclosure relate to wireless network control protocols for adapting wireless system parameters for managing network congestion.

Current production motor vehicles, such as the modern-day automobile, may be originally equipped with a network of onboard controllers, sensors, and communications devices that enable a variety of vehicle services, such as navigation assistance, wireless connectivity, and multimedia entertainment. To provide occupants with telecommunications and informatics functionality, many passenger compartments are now furnished with a center-stack telematics unit that operates as both a human-machine interface (HMI) and an in-vehicle computing device. In general, the telematics unit functions as a bidirectional radio transceiver that is able to simultaneously transmit and receive data in various forms, including as network data packets for WiFi connectivity. Data packets may be transmitted by ultra-high frequency (UHF) or super-high frequency (SHF) radio signals from a cell tower to a cellular-enabled vehicle via downlink (or “download”) transmission and, conversely, may be transmitted from the vehicle to the tower via uplink (or “upload”) transmission.

Many modern automobiles provide occupants with WiFi connectivity that may be used for various applications, from accessing the Internet to streaming digital radio and video content we well as providing a Wi-Fi hotspot to devices brought onboard the vehicle. Along with WiFi network access, vehicles may offer other wireless features, such as BLUETOOTH® and ultra-wideband (UWB) connectivity, that operate on the same radio-frequency (RF) bands as WiFi and, thus, amplify network congestion and affect service quality. Current Wireless Local Access Network (WLAN) systems typically govern network traffic using a WiFi access point (AP) that controls the priority of traffic using fixed Quality of Service (QoS) settings known as Enhanced Distributed Channel Access (EDCA) parameters. However, these EDCA parameters are typically set to fixed “default” values in current WiFi standards. Using fixed, default EDCA parameters in high-congestion scenarios may result in more frequent frame collisions with a concomitant degradation of network performance.

### SUMMARY

Presented herein are wireless communication systems with attendant control logic for dynamic adaptation of communication system parameters for managing network congestion, methods for manufacturing and methods for operating such communications systems, and motor vehicles equipped with such systems. By way of example, systems and methods are presented for mitigating WiFi network congestion by dynamically adapting Enhanced Distributed Channel Access parameters and Energy Detection (ED) and Packet Detection (PD) thresholds. As opposed to using fixed/default system settings instituted by a commercial access point (AP), EDCA, ED, and PD parameters may be adapted based on a predictive congestion score that is calculated as a function of predefined network congestion features (also referred to therein as “traffic factors”), e.g., to help ensure fairness and legacy-device compatibility while offering flexible coordination options (local, centralized, or hybrid).

A significant challenge in dynamically adjusting EDCA parameters is ensuring equitable access and functionality among heterogeneous user devices, as altering the parameters for one device may negatively affect use of other devices. To address this issue, disclosed wireless communication systems may implement multiple ameliorative mechanisms, including a closed feedback loop to reassess parameter changes and a set of predefined contingency features for redressing inimical parameter changes. In congestion scenarios, existing network architectures often include a mixture of devices, some of which use legacy Distributed Coordination Function (DCF) or static EDCA-based access control settings. To help ensure compatibility and coexistence between legacy devices and those with dynamic EDCA capabilities, the disclosed framework may selectively adjust specific parameters to prevent any reversal of priorities and, thus, help to ensure smooth coexistence and minimal disruption to both kinds of devices.

Due to the complexity involved in deriving real-time network conditions, which may be critical to effective evaluation and adjustment of system parameters, existing network protocols are typically unable to provision intelligent dynamic adaptation of EDCA parameters. Disclosed wireless communications architectures, on the other hand, may implement a novel network congestion monitoring and measurement system and algorithm that calculate a congestion score predictive of network congestion using real-time raw network traffic data. This score provides a dynamic basis for adjusting EDCA parameters and, thus, ensuring they may be continuously optimized in response to changing congestion levels. Also introduced is a flexible coordination framework for adapting EDCA/ED/PD parameters through local, centralized, and/or hybrid coordination to provision adaptable network management strategies based on the specific needs of the environment.

Aspects of this disclosure are directed to methods for making and methods for using any of the herein described wireless communication systems. In an example, a method is presented for operating a wireless communication system, such as a WiFi-enabled centerstack telematics unit of a motor vehicle. This representative method includes, in any order and in any combination with any of the above and below disclosed options and features: monitoring, e.g., via a resident or remote microprocessor, central controller, control module, programmable logic device, or network of processors/controllers/modules/devices (collectively “system controller”) through an API, SDN or WiFi driver, a mixture of network traffic factors that affect network congestion of the wireless communication system to generate raw network traffic data; transforming, e.g., via the system controller, the raw network traffic data based on a processing rule set to generate processed traffic data; calculating, e.g., via the system controller using a trained machine-learning (ML) model, a congestion score as a function of the network traffic factor values within the processed traffic data, each of which is weighted using a respective weight factor assigned to its corresponding traffic factor within the network traffic factors; determining, e.g., via the system controller, if the congestion score exceeds a congestion threshold value; and, responsive to determining the congestion score exceeds the congestion threshold value, modulating operation of the wireless communication system by adjusting one or more system WiFi/WLAN parameters based on the congestion score.

Aspects of this disclosure are also directed to computer-readable media (CRM) containing controller-executable instructions for provisioning dynamic adaptation of WiFi/WLAN parameters for network congestion management. In an example, a non-transient CRM stores instructions that are executable by a system controller of a wireless communication system. These CRM-stored instructions, when executed, cause the system controller to perform operations that include: monitoring multiple network traffic factors affecting a network congestion of the wireless communication system to generate a raw network traffic data set; transforming the raw network traffic data set based on a processing rule set to generate a processed traffic data set; calculating, using a trained machine-learning (ML) model, a congestion score as a function of multiple traffic factor values within the processed traffic data set each weighted using a respective weight factor assigned to a corresponding traffic factor within the network traffic factors; determining if the congestion score exceeds a congestion threshold value; and modulating, responsive to determining the congestion score exceeds the congestion threshold value, operation of the wireless communication system by adjusting multiple system WiFi/WLAN parameters based on the congestion score.

Additional aspects of this disclosure are directed to motor vehicles equipped with smart wireless communication systems that dynamically adapt system parameters to manage fluctuations in network congestion. As used herein, the terms “vehicle” and “motor vehicle” may be used interchangeably and synonymously to reference any relevant vehicle platform, such as passenger vehicles, commercial vehicles, industrial vehicles, off-road and all-terrain vehicles, tracked vehicles, farm equipment, motorcycles, watercraft, aircraft, spacecraft, etc. In an example, a motor vehicle includes a vehicle body with a passenger cabin, multiple road wheels attached to the vehicle body (e.g., via corner modules coupled to a unibody or body-on-frame chassis), and other standard original equipment. A prime mover, which may be in the nature of an electric traction motor and/or an internal combustion engine (ICE) assembly, is located inside the vehicle body and drives the road wheel(s) to propel the vehicle. Located inside the vehicle passenger cabin is a wireless communication system, such as a centerstack telematics unit, that wirelessly exchange network data packets with a remote distributed computing system.

Continuing with the discussion of the foregoing example, the vehicle is also equipped with a resident or remote system controller that is programmed to monitor a mixture of network traffic factors that affect network congestion of the wireless communication system to generate a set of raw network traffic data. The system controller then transforms the raw network traffic data based on a predefined processing rule set to generate a set of processed traffic data. Using a trained ML model, the system controller then calculates a congestion score as a function of the traffic factor values contained in the processed traffic data set, each of which is weighted using a respective weight factor that is assigned to its corresponding traffic factor within the network traffic factors. In response to a determination that the congestion score exceeds a system-calibrated congestion threshold value, the system controller modulates operation of the wireless communication system by adjusting one or more system WiFi parameters based on the congestion score.

For any of the disclosed wireless communication systems, vehicles, and methods the congestion score may be calculated as a combination of wireless medium congestion-indicator features. For instance, the congestion score may be calculated as:

$${S}_{vt} = {\sum }_{i = 1}^{I} {w}_{i} {f}_{i}$$

where Sₜ is a congestion score for a vehicle v within a traffic type t, fᵢ is an i^{th} congestion-indicating traffic factor value, v is the reporting vehicle, t and wᵢ is the respective weight factor assigned to the corresponding i^{th} congestion-indicating traffic factor. After adjusting the system's WiFi/WLAN parameters, closed-loop feedback control may be provided by monitoring the network traffic factors (e.g., wireless medium congestion indicator features) to generate a new set of raw network traffic data, and transforming the new raw network traffic data based on the processing rule set to generate a new set of processed traffic data. For example, values of instantaneous/average latency or throughput by all stations in the WLAN network may be collected. These fresh values are gain that may be used to recompute a fresh congestion score. In an example, a new congestion score may then be calculated as a the function of the new traffic factor values in the new processed traffic data, each weighted using its respective weight factor. Responsive to the new congestion score exceeding the prior congestion score, which is indicative of an increase in network congestion, the system controller may reset the system's WiFi parameters to a set of system-calibrated default WiFi settings.

For any of the disclosed systems, vehicles, and methods, the system controller may retrieve a set of system-calibrated maximum and minimum (max/min) allowable WiFi parameter values; in this instance, adjusting the system's WiFi parameters may be limited by the system's max/min allowable WiFi parameter values. The congestion threshold value may be delineated into a hierarchy of threshold values, including low, moderate, and high-congestion threshold values. Upon determining that the congestion score exceeds the moderate-congestion threshold value, the system controller may responsively adjust the system's WiFi parameters to a set of moderate congestion parameter values that prioritize select data transmission types to/from the wireless communication system. Responsive to a determination that the congestion score exceeds the high-congestion threshold value, the system controller may adjust the system's WiFi parameters to a set of high congestion parameter values that significantly limit preselected data transmission types to/from the wireless communication system.

For any of the disclosed systems, vehicles, and methods, adjusting the system's WiFi parameters may include: increasing respective parameter values for a set of EDCA parameters (e.g., aCwmin, aCwmax, AIFSN, TXOP, etc.) and thereby prioritize select types of data packets received by the wireless communication system; raising a PD threshold value (e.g., Receiver Start of Packet Detection Threshold (RX-SOP)) and thereby delimit a signal level at which the wireless communication system demodulates and decodes data packets; and/or raising an ED threshold value (e.g., 802.11 transmission ED threshold measured in decibel milliwatt (dBm)) and thereby delimit a noise level at which the wireless communication system detects an RF transmission. As a further option, transforming raw network traffic data may include aggregating, averaging, smoothing raw data, and/or extracting a min, max, or mean deviation value of raw data in the raw network traffic data set within a specified time window.

For any of the disclosed vehicles, systems, and methods, the system controller may actively determine whether the congestion score is below the congestion threshold value (e.g., “low congestion score”); if so, the system controller may responsively modulate operation of the wireless communication system by setting the system's WiFi parameters to a set of system-calibrated default WiFi settings. In this instance, the system controller may also lower a PD threshold value and/or an ED threshold value of the wireless communication system in response to the congestion score not exceeding the moderate or high congestion threshold values. As another option, monitoring network traffic factors may include the system controller communicating through a WiFi network module and/or a software-defined networking (SDN) device with a WiFi driver and/or a WiFi application program interface (API) to measure the network traffic variables in real-time and generate therefrom the raw network traffic data. It is envisioned that any of the herein described wireless system control protocols may be utilized in vehicular and non-vehicular applications alike.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with a network of in-vehicle controllers, sensors, and communication devices for provisioning dynamic adaptation of wireless communication system parameters for managing network congestion in accord with aspects of the present disclosure.

FIG. 2 is a flowchart illustrating a representative system control protocol for valuating network congestion and dynamically adapting EDCA/ED/PD parameters of a WiFi-enabled wireless communication system, which may correspond to non-transient, memory-stored instructions that are executable by a resident or remote microprocessor, control module, programmable logic circuit, central controller, or other integrated circuit (IC) device or network of controllers/processors/modules/devices/etc. in accordance with aspects of the disclosed concepts.

FIG. 3 is a flowchart illustrating a representative system control subroutine for dynamically adapting EDCA parameters within the control protocol of FIG. 2.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

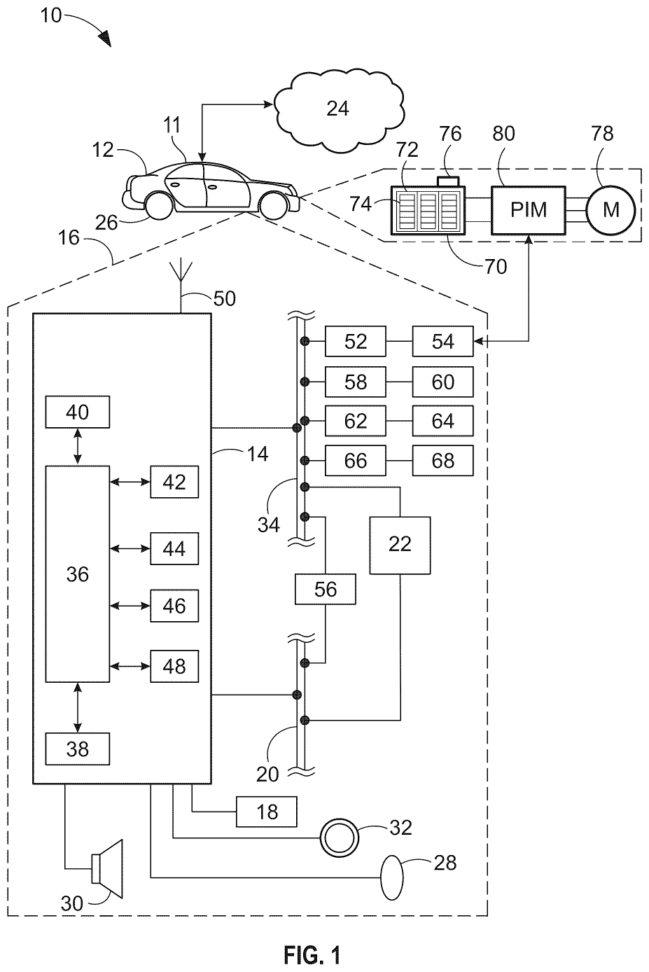

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, utilization of the present concepts for dynamically adapting operation of a WiFi-enabled centerstack telematics unit should also be appreciated as a non-limiting implementation of disclosed features. As such, it will be understood that novel aspects of this disclosure may be employed for operating other WiFi-enabled devices, may be utilized for any logically relevant type of motor vehicle, and may be implemented in vehicular and non-vehicular applications alike. Moreover, only select components of the motor vehicle and wireless communication system are shown and described in detail herein. Nevertheless, the vehicles and systems discussed below may include numerous additional and alternative features, and other available peripheral hardware, for carrying out the various methods and functions of this disclosure.

The representative vehicle 10 of FIG. 1 is originally equipped with a vehicle telecommunications and informatics (“telematics”) unit 14 that wirelessly communicates, e.g., via cellular network, satellite service, wireless-enabled modem, hot spot, etc., with a remotely located cloud computing host service 24 (e.g., ONSTAR®). Some of the other vehicle hardware components 16 shown generally in FIG. 1 include, as non-limiting examples, an electronic video display device 18, a microphone 28, audio speaker(s) 30, and assorted user input controls 32 (e.g., buttons, knobs, switches, touchpads, touchscreens, etc.). These hardware components 16 function, in part, as a human/machine interface (HMI) that enables a user to communicate with the telematics unit 14 and other components resident to and remote from the vehicle 10. Microphone 28, for instance, provides occupants with a means to input verbal commands; the vehicle 10 may be equipped with an embedded voice-processing unit utilizing audio filtering, editing, and analysis modules. Conversely, the speaker 30 provides audible output to a vehicle occupant and may be either a stand-alone speaker dedicated of the telematics unit 14 or may be part of an in-cabin audio system 22. The audio system 22 is connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction and regenerative brake systems, controlling vehicle steering, and other automated functions. For instance, telematics unit 14 may exchange signals with a Powertrain Control Module (PCM) 52, an Advanced Driver Assistance System (ADAS) module 54, a Motor Control Module (MCM) 56, a Body Control Module (BCM) 58, a Sensor System Interface Module (SSIM) 60, and assorted other vehicle ECUs, such as a Transmission Control Module (TCM), a Sensing and Diagnostics Module (SDM), a Brake System Control Module (BSCM), etc.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, solid-state drive (SSD) memory, hard-disk drive (HDD) memory, phase-change memory, flash memory, semiconductor memory (e.g., various types of RAM or ROM), etc.

Long-range communication (LRC) capabilities with remote, off-board devices may be provided via one or more or all of a cellular chipset/component, a navigation and location chipset/component (e.g., global positioning system (GPS) transceiver), a wireless modem, or a mobile hotspot, all of which are collectively represented at 44 in FIG. 1. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual antenna 50. The communications devices described above may provision data exchanges as part of a periodic broadcast in a vehicle-to-vehicle (V2V) communication system or a vehicle-to-everything (V2X) communication system, e.g., Vehicle-to-Infrastructure (V2I), Vehicle-to-Pedestrian (V2P), Vehicle-to-Device (V2D), Vehicle-to-Cloud (V2C), etc.

Vehicle CPU 36 receives sensor data from one or more sensing devices that use, in non-limiting examples, photo detection, radar, laser, ultrasonic, optical, infrared, or other suitable technologies, including short range communications technologies (e.g., DSRC) or Ultra-Wide Band (UWB) radio technologies, for executing a controller-automated (AV/ADAS) driving operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automated vehicle operation.

To propel the automobile 10, a vehicle powertrain is operable to generate and deliver tractive torque to one or more of the vehicle's drive wheels 26. The powertrain is represented in FIG. 1 by an electric traction motor (M) 78 that is operatively connected to a rechargeable energy storage system (RESS), which may be in the nature of a chassis-mounted traction battery pack 70. The traction battery pack 70 is generally composed of one or more battery modules 72 each containing a cluster of battery cells 74, such as lithium-class, zinc-class, nickel-class, or organosilicon-class cells of the pouch, prismatic, or cylindrical type. One or more prime movers, such as traction motor/generator (M) units 78, draw electrical power from and, optionally, deliver electrical power to the battery pack 70. A power inverter module (PIM) 80 electrically connects the battery pack 70 to the motor(s) 78 and modulates the transfer of electrical current therebetween. The battery pack 70 may include an integrated electronics package, such as a wireless-enabled cell monitoring unit (CMU) 76, that enables on-module management, cell sensing, etc.

Discussed below are smart wireless communication systems with control logic for active management of network congestion using a framework that dynamically evaluates and adapts EDCA parameters and ED/PD thresholds based on predictive congestion scoring that is calculated as a function of measurable network congestion features (also referred to herein as “traffic factors”. Disclosed systems and logic may help ensure device access and functionality fairness and legacy-device compatibility while offering flexible system coordination. A system congestion measurement subcomponent of this framework derives a congestion score that is predictive of real-time network traffic congestion. A congestion score may be calculated based on a weighted combination of congestion factors. The factor weights may be fixed pre-determined values (e.g., learned through a supervised and trained ML model) or variable values (e.g., systematically adjusted in view of system response). For instance, weighting values may be dependent on the type of network traffic: (a) for real-time voice users, factors such as latency, jitter, and packet loss may be given higher weight since there is no buffering in voice traffic; and (b) for video streaming users, factors such as jitter and latency may be given less weight, since there is buffering in video traffic, whereas throughput may be given more weight. Jitter, latency, and similar factors may be given less weight because there is usually some buffering in streaming videos, e.g., when a user is streaming a video from the Internet, some of it may be pre-loaded in temporary memory. Comparatively, an occupant using in-vehicle voice services to talk to another person via a phone call is a real-time use case; as such, latency and jitter might be deemed more important for voice users.

A host vehicle may calculate a congestion score independently or in conjunction with multiple crowd-sourced vehicles. In the latter option, each vehicle may independently calculate a congestion score based on individual factor measurements and then report their score to a shared access point; the AP aggregates the reported scores to calculate a collective congestion score. Alternatively, a host vehicle may conduct a V2V exchange with neighboring vehicles to share congestion scores and thereby gain a broader view of network congestion. Non-limiting examples of traffic congestion factors may include channel utilization, packet loss rate, average queue length, retransmission rate, signal-to-noise ratio (SNR), signal-to-interference-plus-noise ratio (SINR), throughput, latency, jitter, bandwidth usage, and clear channel assessment (CCA) failure rate/collision rate. A practical network congestion factor that may be accessible and exposed in a WiFi chipset may include an 802.11 MAC-layer transmit opportunity (TXOP) bounded time interval. For practical implementation, network traffic factors that are fetched form only one layer may be more feasible to track (e.g., MAC layer features only); the rest may be considered optional based on latency and computational complexity requirements/constraints.

Coexistence-related traffic factors that may be monitored for congestion scoring include a scanned, detected level of energy in the WiFi channels or bands. A host vehicle may monitor such features through multiple tools:
(i) tools or libraries may be integrated into a host vehicle's WiFi system to monitor network performance, e.g., an SDN-like controller could monitor a vehicle entire state;
(ii) a vehicle WiFi module may monitor these metrics through native WiFi drivers and APIs that provide access to these measurements;
(iii) a host vehicle may passively monitor these factors by listening to management frames, e.g., beacon and probe requests/responses from other APs and stations (STAs) in their vicinity (e.g., a Traffic Indication Map (TIM) is an information element in beacon frames that informs STAs about the status of buffered data at the AP);
(iv) a packet sniffing device to capture and analyze data packet traffic at the MAC layer via tools or libraries (e.g., Wireshark open-source analyzer);
(v) vehicles may send probe requests to APs (e.g., round-trip time (RTT) may be used to estimate latency); and/or
(vi) 802.11 k with Radio Resource Management (RRM) (e.g., standard 802.11k) may provide information to discover the best available access point.
   These methods of retrieving network congestion features/factors are not limited to congestion-related features, but may be implemented for other features, including SINR, throughput, latency, queue length, packet loss rate, etc. Access points may also collect and share information about their radio environment, such as channel usage, signal strength, and interference levels. As a further option, an AP Simple Network Management Protocol (SNMP) or a resident WiFi interface may gather data directly from the MAC layer (e.g., vehicle can monitor queue length).

Also presented herein are system control methods for dynamically adapting the wireless communication system's EDCA operating parameters and, optionally, ED/PD thresholds to address changes to network congestion. Using a multimodal congestion score, for example, the method adaptively adjusts system parameters based on a set of predefined system-calibrated rules. These predefined rules may be derived from empirical analysis and testing, statistical/ML models (e.g., decision tree), network simulation and modeling, industry standards and best practices, or any combination of the foregoing. A continuous feedback loop may be implemented after each system parameter change to provide error correction and continuous improvement of the control algorithm. For the feedback loop, a new set of traffic factor values is fed back into the congestion scoring and evaluation algorithm and, if the congestion score decreases, the adapted EDCA parameter values are maintained. Conversely, if the congestion score increases and, thus, the adapted parameters are exacerbating congestion, the system parameters may be switched to a set of default EDCA parameters.

Disclosed smart wireless communication system may account for fairness when adapting system parameters to ameliorate any negative affect that a parameter change has on other user devices. This may be achieved through several mechanisms:
i) a feedback loop may systematically assess the effect of parameter changes and revert back to default parameter values if the subject changes are causing fairness issues;
ii) limits may be set on the max/min EDCA parameter values to ensure that any parameter changes stay within predefined bounds;
iii) AP involvement in solution may ensure a marked level of coordination;
iv) in case of extreme congestion, each AP may randomly select a percentage of their clients and move them to a best effort or background, e.g., to induce an opportunity for these clients to go through, and then select a different set of clients, and so on. This percentage may be based on the amount of detected congestion around the AP; and/or
v) combine existing load balancing techniques more aggressively when dynamic EDCA is enabled (e.g., in a multi-AP scenario, ensure clients are automatically connected to a least congested AP).
   The system may take into account compatibility with DCF-only “legacy” devices by only adapting select EDCA system parameters (e.g., changing CWmax and not CWmin) when legacy DCF is available to avoid an unwanted reversal of priorities.

In addition to the dynamic adaptation of EDCA parameters, disclosed wireless communication systems and control protocols may also adapt ED and PD thresholds to offset changes in traffic congestion. Current 802.11 standards implement fixed values for ED thresholds (e.g., set to 20 dB above signal detect threshold). This fixed threshold, however, may be suboptimal for high congestion scenarios. Rather than using a fixed ED threshold, disclosed systems and methods may use a calculated congestion score to dynamically adapt the ED threshold to alleviate network traffic congestion. For instance, ED thresholds may be raised in high congestion scenarios to reduce the probability of interference and detection of irrelevant signals, false detection, and preventing further congestion. Conventional control algorithms also fix PD thresholds at a set radio default value. Like fixed ED thresholds, fixed PD thresholds may be suboptimal for congestion scenarios. Disclosed systems and methods may use the calculated congestion score to dynamically adapt the PD threshold to alleviate network traffic congestion. For instance, PD thresholds may be raised in high congestion scenarios to reduce the chances of interference and detection of irrelevant signals, false detection, and preventing further congestion. Similar fairness mechanisms as those described above for adapted EDCA parameters may be put in place for adapted ED and PD thresholds.

Depending on a given operating scenario, the EDCA/PD/ED adjustments may be applied at a global level (e.g., centrally coordinated AP-centric), at a local level (e.g., device or STA-centric), or in accord with a hybrid local-global approach. For AP-centric approaches, an AP may collect traffic information by continuously monitoring network conditions and receiving feedback from STAs regarding metrics, such as SINR, PER, etc. Based on the collected data, the AP may compute a set of “optimal” EDCA parameters for a given operating scenario. Afterwards, the AP may broadcast current EDCA parameters, computed “optimal” parameters, and/or indicate when a change is needed using existing signaling, such as action or beacon frames. Individual STAs may then update their system parameters as per the AP's broadcast instructions.

In STA-centric approaches, an STA may independently evaluate and adapt its own EDCA parameters based on local measurements and network conditions. Each STA, for example, may monitor local conditions, such as PER, SINR, etc., and then adjust parameters locally. The AP may still provide coordination if needed, such as providing general guidelines or threshold values through beacon or action frames. If an STA needs help from an AP to make network-wide decisions, the STA may transmit optional feedback data to its AP through action frames about their conditions and adjustments. The AP may then respond with an action protocol and parameter updates.

In hybrid approaches, the AP may provide a set of general network-wide parameter guidelines and thresholds (e.g., max or min allowable values for CWmin, CWmax, and other parameters). Each STA may make fine-grain adjustments within those bounds based on its own local conditions. This may provide both the benefits of coordination and the flexibility of local adaptation.

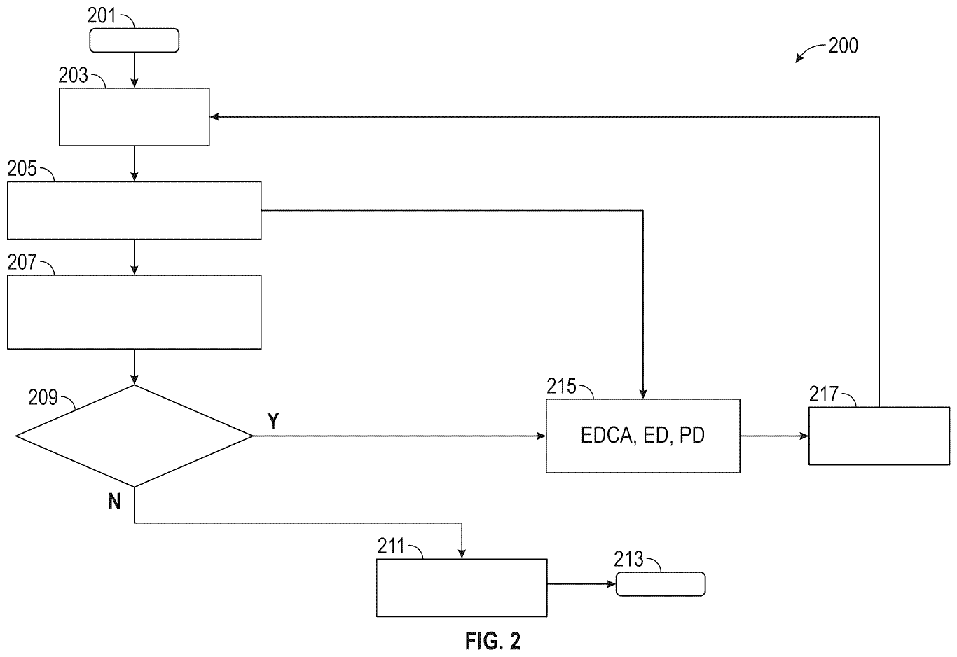

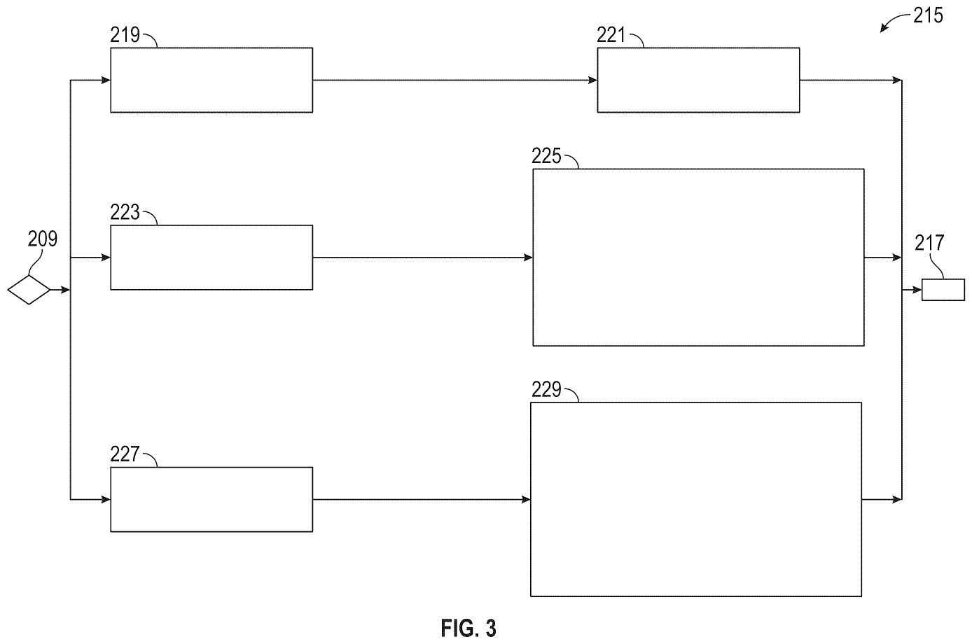

With reference next to the flowchart of FIG. 2, an improved method or control protocol for valuating network congestion and dynamically adapting system operating parameters of a wireless communication system, such as WiFi-enabled vehicle telematics unit 14 of FIG. 1, is generally described at 200 in accordance with aspects of the present disclosure. Presented in FIG. 3 is a representative system control subroutine 215 for dynamically adapting EDCA parameters as part of the control protocol 200 of FIG. 2. Some or all of the operations illustrated in FIGS. 2 and 3 and described in detail below may be representative of an algorithm that corresponds to non-transitory, processor-executable instructions that may be stored, for example, in main or auxiliary or remote memory (e.g., resident vehicle memory 38 and/or remote cloud host service 24 database of FIG. 1). These instructions may be executed, for example, by a resident or remote microprocessor, central controller, dedicated control module, programmable logic circuit, or other module or device or network of processors/controllers/modules/devices (e.g., vehicle CPU 36 and/or cloud host service 24 server-class computer terminal of FIG. 1) to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 may begin at START terminal block 201 of FIG. 2 with memory-stored, computer-readable instructions for initializing a WiFi EDCA parameter adaptation control protocol for a wireless communication system. This routine may be initialized in real-time, near real-time, continuously, systematically, sporadically, and/or at predefined time intervals, for example, each 10 or 100 milliseconds during operation of the motor vehicle 10. As yet another option, terminal block 201 may initialize responsive to a user command prompt (e.g., via telematics input controls 28, 32), a resident vehicle controller prompt (e.g., from CPU 36), or a broadcast prompt signal received from a centralized BO vehicle services system (e.g., from cloud host service 24). By way of non-limiting example, method 200 may automatically initialize during a key-on event in which a driver, owner, occupant, or other authorized operator of the vehicle 10 (collectively “user”) powers on the vehicle powertrain or enters vehicle accessory mode. Upon completion of some or all of the control operations presented in FIG. 2, method 200 may advance to END terminal block 213 and temporarily terminate or, optionally, may loop back to terminal block 201 and run in a continuous loop. Terminal block 213 may automatically trigger in response to a key-off event in which a user powers off the vehicle powertrain or in response to a user turning off the vehicle's accessory mode.

From terminal block 201, method 200 may advance to TRAFFIC FACTOR data input block 203 to aggregate traffic congestion feature information that will be utilized by the control protocol to derive a congestion score that is predictive of real-time network traffic congestion. Using the vehicle telematics unit 14 of FIG. 1 as a non-limiting example, the CPU 36 may monitor and measure a variety of different network traffic factors that affect network congestion of the vehicle's wireless LRC system 44 to generate raw network traffic data. Example traffic congestion factors may include: channel utilization, packet loss rate, packet queue length, data retransmission rate, SNR/SINR, packet throughput, data latency (“ping”), data jitter, bandwidth usage, CCA failure rate/collision rate, TXOP (e.g., accessible and exposed in WiFi chipset), scanned detected level of energy in channels/bands, etc. As mentioned above in the discussion of available traffic monitoring tools, network traffic factors may be monitored by the system controller by communicating through a WiFi network module and/or an SDN device with a WiFi driver and/or a WiFi API to measure one or more of the network traffic variables in real-time.

After aggregating traffic feature information and concomitantly generating raw network traffic data, method 200 executes DATA PREPROCESSING subroutine 205 to perform real-time data preprocessing and feature extraction. Vehicle CPU 36 of FIG. 1 may employ a supervised and trained ML model, such as a decision tree-based algorithm or K-nearest neighbor (kNN) model, to transform raw network traffic data based on a set of predefined processing rules to generate processed traffic data. Transforming raw network traffic data to extract therefrom traffic factor values may include-within a specified time window-aggregating, averaging, and smoothing raw data, which may then be analyzed to identify maximum, minimum, and/or mean deviation values in the data set. The traffic congestion factors described in the previous paragraph may be categorized as ‘raw features’. In an AI-model training pipeline, these raw features may be transformed by first preprocessing the data to make the information more insightful; preprocessed data may then be feed into an ML model or used to develop a non-ML model. Example preprocessed features may include: packet loss rate over a specific time window that is averaged or smoothed (instead of using instant values); latency averaged over multiple packets to obtain an average/min/max latency; and jitter processed using mean-deviation or moving-average smoothing. Other traffic congestion factors may be aggregated and filtered to remove outliers, discretize continuous data streams, and fuse data from discrete sources. Processed network traffic data may be output to subroutine 207 for calculating a predictive congestion score and to subroutine 215 to facilitate dynamic adaptation of the system's operating parameters.

Method 200 may thereafter execute CONGESTION PREDICTION subroutine 207 at which a pre-trained ML model uses the assorted traffic factor values contained in the processed traffic data to estimate a real-time level of network congestion. Vehicle CPU 36 of FIG. 1, for example, may calculate a congestion score as a function of multiple traffic factor values within a processed traffic data set, each of which may be weighted using a respective weight factor that is assigned to its corresponding traffic factor in the set of network traffic factors (e.g., latency value Lᵥᵢ weighted by latency weight factor w_{L} assigned to data latency time within memory-stored listing of traffic factors). For a vehicular application, the congestion score may be calculated as:

$${S}_{vt} = {\sum }_{i = 1}^{I} {w}_{i} {f}_{i}$$

where Sₜ is a congestion score for a subject (host) vehicle v within a traffic type t; fᵢ is an i^{th} traffic factor value of the traffic factor values in the processed traffic data set; and wᵢ is the respective weight factor assigned to the corresponding traffic factor of the i^{th} traffic factor value. As noted above, each weight factor w may be a fixed pre-determined value or may be a dynamically variable value. As per the latter, a weight factor w may be dependent on the current type of traffic t being experienced by the host vehicle v. It should be appreciated that the foregoing mathematical formula is just one example by which a congestion score may be calculated.

In the above equation, some subscripts may be deemed implicit, such as traffic factor fᵢ, which may also have hidden subscripts v and t. For example, the first feature may be average latency, and fₗ is an average latency value based on the raw feature Latency. This average latency value belongs to a vehicle v, and each vehicle v may also contain multiple devices and multiple traffic types t. Likewise, weight factor w may have an implicit subscript t. A supplemental summation may be calculated for f from j=1 to T, where T is the traffic type because a host vehicle v may experience more than one type of traffic t.

After calculating the congestion score, method 200 proceeds to CONGESTION EVALUATION decision block 209 to ascertain whether or not the wireless communication system is experiencing elevated levels of network traffic congestion. In accord with the example illustrated in FIG. 1, the vehicle CPU 36 may determine if and when the calculated congestion score is greater than a predefined congestion threshold value (Sᵥₜ>S_{CT}) calibrated to the vehicle's wireless LRC system 44. When the congestion score does not exceed the congestion threshold value (Block 209=NO), method 200 may responsively execute SYSTEM PARAMETER DEFAULT process block 211 with memory-stored, processor-executable instructions for the vehicle CPU 36 to modulate operation of the centerstack telematics unit 14 mounted inside passenger cabin 11 by setting the system's WiFi parameters to a set of system-calibrated default WiFi settings. If the wireless communication system parameters are already set to factory default values, vehicle CPU 36 may take no action other than verifying that the default values are properly set. On the other hand, process block 211 may include: (1) adapting the system's currently set EDCA parameter values to their respective default parameter values; (2) lowering the system's current PD threshold value from a moderate/high-congestion PD value to a default PD value; and/or (3) lowering the system's current ED threshold value from a moderate/high-congestion ED value to a default ED value. At this juncture, method 200 may proceed to terminal block 213 and temporarily terminate or may automatically loop back to data input block 203.

Upon determining that the calculated congestion score does exceed the congestion threshold value (Block 209=YES), method 200 may responsively execute SYSTEM PARAMETER ADAPT subroutine 215 and dynamically adapt the system's EDCA/ED/PD parameters. To help ameliorate data traffic congestion, packet prioritization over a particular WiFi channel may be dictated by the values set for the system's Enhanced Distributed Channel Access parameters. In other words, a system's EDCA settings may delineate high-priority network traffic, which will have a greater chance of being sent, than low-priority network traffic, which will have a lower chance to transmit on the wireless channel. A high-priority data packet, for example, may wait less time before being transmitted to/from a subject device, on average, as compared to a low-priority data packet. This may be accomplished by using a shorter contention window (CW) and a shorter arbitration inter-frame space (AIFS) for high-priority packets. The exact parameter values set for CW/AIFS may depend on the physical WiFi layer that is used to transmit the data. EDCA may also provide “contention free” access to a channel for a fixed period of time called a Transmit Opportunity. Similar functionality of rendering a high-priority channel could also be achieved via using upper layer protocol components, such as transmission control protocol (TCP) variants that manipulate a backoff window of TCP protocols.

When a congestion score is obtained and shown to exceed a congestion threshold, the congestion measurement and evaluation model predicts that sufficient network congestion is present to activate a dynamic EDCA/ED/PD adaptation algorithm. Referring again to the use case example of FIG. 1, the vehicle CPU 36 may respond to a determination that the calculated congestion score exceeds the congestion threshold value by adjusting multiple system WiFi parameters based, at least in part, on the congestion score. Prior to initializing any new system settings, the vehicle CPU 36 may first retrieve a set of system-calibrated max/min WiFi parameter values (e.g., those output from subroutine 205); any adjustments to the system's WiFi parameters may be constrained by these system-calibrated max/min WiFi parameter values. Adaptive adjustment of system parameters for managing network congestion may also be governed by a predefined parameter adaptation rule set. These rules may be derived from empirical analysis and testing, statistical/ML models, industry standards and best practices, network simulation, emulation, and modeling, or any combination thereof. As further indicated by the arrow connecting subroutine 205 with subroutine 215 of FIG. 2, some or all of the extracted feature values output from subroutine 205 may be used to generate the parameter adaptation rules. However, it may be desirable that these rules are predetermined fixed restrictions and, thus, will not be generated in real-time.

Congestion score-based adaptation of WiFi or non-WiFi system operating parameters may include increasing the respective parameter value for each of the system's EDCA parameters to prioritize transmission of select types of network data packets. FIG. 3 presents a representative system control subroutine or method 215 for dynamically adapting EDCA parameters. In this non-limiting example, the congestion threshold value is not a single value (as described above) but rather may be delineated into a hierarchy of threshold values: (1) a low-congestion range (e.g., S_{LCT}=0.02 to 0.39), (2) a moderate-congestion threshold value (e.g., S_{MCT}=0.40), and (3) a high-congestion threshold value (e.g., S_{HCT}=0.70). At LOW CONGESTION process block 219, method 200 may determine that the calculated congestion score is within the low-congestion range and therefore predicts that the wireless communication system is currently experiencing low traffic congestion (Sᵥₜ<0.4). Method 200 may responsively execute PRESERVE EDCA process block 221 and not make any changes to the EDCA parameters. Method 200 may thereafter advance from process block 221 to subroutine 217 or terminal block 213. It should be appreciated that the numbers presented in FIG. 3 are provided for illustrative purposes and are therefore non-limiting in nature.

At MODERATE CONGESTION process block 223 of FIG. 3, method 200 may determine that the calculated congestion score is greater than the moderate-congestion threshold value (0.40<Sᵥₜ<0.70). In this instance, method 200 may responsively execute KEY SERVICES process block 225 and adjust the system's EDCA parameters to a set of moderate-congestion parameter values that prioritize select “priority services” data transmission types to/from the wireless communication system. To prioritize key services, the system's EDCA parameters may be adjusted as follows: (i) minimum contention window integer (aCwmin[AC_BE]): 15→31; (ii) maximum contention window integer (aCwmax[AC_BE]): 1023→2047; (iii) Arbitration Interframe Space Number AC-BE parameter record (AIFSN[AC_BE]): 5→7; (iv) Arbitration Interframe Space Number AC-BK parameter record (AIFSN[AC_BK]): 7→15; and (v) TXOP[AC_VO]: 1.5→3. Method 200 may thereafter advance from process block 225 to subroutine 217.

At HIGH CONGESTION process block 227 of FIG. 3, method 200 may determine that the calculated congestion score is greater than the high-congestion threshold value (Sᵥₜ>0.7). In this instance, method 200 may responsively execute ESSENTIAL SERVICES process block 229 and adjust the system's EDCA parameters to a set of high congestion parameter values that that significantly limit preselected “non-essential” data transmission types to/from the wireless communication system. To prioritize essential data transmissions, the system's EDCA parameters may be adjusted as follows: (i) aCwmin[AC_BE]: 15→63; (ii) aCwmax[AC_BE]: 1023→4095; (iii) AIFSN[AC_BE]: 5→9; (iv) AIFSN[AC_BK]: 7→31; and (v) TXOP[AC_VO]: 1.5→5. Method 200 may thereafter advance from process block 229 to subroutine 217.

In tandem with changes to the system's EDCA parameter settings, method 200 may add an extra layer of system enhancement by dynamically adapting the system's energy detection and packet detection thresholds and, in so doing, modulate when and how the system's receiver may decode received data. The ED threshold may be implemented when non-WiFi signals are present and the PD detection threshold may be implemented when WiFi signals are present. Both of these thresholds may be a core part of clear channel assessment that may be used by a contention-based channel access mechanism utilized by EDCA to prioritize different types of traffic. During low network congestion scenarios, method 200 may lower the ED and PD thresholds to respectively lower the signal energy level at which the system detects a signal and lower the measured energy at which the system determines a complete data packet is received. Conversely, during high network congestion, method 200 may raise the ED and PD thresholds to limit which signals are detected and which packets are received. In a congested network environment, for example, subroutine 215 may raise the PD threshold value and thereby delimit a signal level at which the wireless communication system demodulates and decodes data packets. At the same time, the system may raise the ED threshold value and thereby delimit a noise level at which the system detects an RF transmission. In a congested environment, there's a higher chance that weak signals, such as those from nearby devices or sources of interference, may affect communication. By raising the ED and PD thresholds, the system would ignore these weaker, irrelevant signals, thus reducing device interference and noise outside the intended communication range.

By way of context, an 802.11-compliant radio system may decode an incoming 802.11 preamble transmission at a received signal of about 4 decibels (dB) above the noise floor. The system's energy detection threshold may be set to enable the system to detect other types of RF transmissions during a clear channel assessment (CCA). For example, if the noise floor of channel 36 were at −95 dBm, the SD threshold for detecting 802.11 transmissions may be set to around −91 dBm, and the ED threshold for detecting other/non-WiFi RF transmissions may be set to around −71 dBm. In this example, the ED threshold may be lowered during a low congestion/coexistence score and may be raised during a high congestion/coexistence score to filter out noise and reduce false positives. Comparatively, a receiver's Start of Packet Detection Threshold (RX-SOP) may determine the Wi-Fi signal level in dBm at which an AP radio will demodulate and decode a packet. Increasing the system's RX-SOP value limits the AP radio to decoding packets with a higher RSSI value. If congestion score indicates low congestion, the PD threshold may be lowered to accept more packets; otherwise, the PD threshold may be raised in unstable, congested conditions to reduce unnecessary processing.

After adapting the system's WiFi operating parameters at subroutine 215, method 200 of FIG. 2 may implement a continuous feedback loop (represented by arrow connecting block 217 to block 213) to systematically assess the effect of the parameter changes and, if the newest changes are causing congestion or fairness issues, revert back to default parameters. To initiate the feedback loop, method 200 may execute NEW FEATURE VALUES data input block 217 and retrieve new traffic congestion feature information using the adapted parameters to derive a new congestion score that is predictive of any resultant changes to traffic congestion. In response to adjusting the system WiFi parameters, for example, Vehicle CPU 36 of FIG. 1 may monitor and measure the network traffic factors to generate a new set of raw network traffic data, e.g., in a manner similar to that described above with respect to data input block 203. After generating new raw network traffic data, vehicle CPU 36 may once again employ the trained SML model to process the new raw network traffic data using the processing rule set to generate a new set of processed traffic data and extract therefrom relevant traffic factor values, e.g., at data input block 205.

Method 200 may thereafter re-execute CONGESTION PREDICTION subroutine 207 and calculate a new congestion score as a function of the new traffic factor values extracted from the new set of processed traffic data, each of which is weighted by its respective weight factor. Method 200 may then juxtapose the new congestion score with the prior congestion score; if the new congestion score exceeds the prior congestion score, i.e., suggesting that network traffic congestion has increased with the adapted WiFi parameters, method 200 may responsively reset the system's WiFi parameters to the system-calibrated default WiFi settings. On the other hand, if the new congestion score is lower than the prior, i.e., suggesting that network traffic congestion has decreased with the adapted WiFi parameters, method 200 may maintain the adapted parameter values or may make additional adjustments to offset traffic congestion. Additional mechanisms may be implemented to ensure compatibility with legacy devices; for instance, when a legacy device is detected, the system may responsively change only a select subset of parameters without modifying other system parameters that may cause reversal of traffic priorities (e.g., only change EDCA CWmax parameter to ensure legacy device compatibility).

Orchestration of the above-described dynamic adaption systems and methods may be carried out using an access point (AP) centric decision making protocol, a station/device (STA) centric decision making protocol, or a hybrid AP/STA decision making protocol. For AP-centric decision making, an AP may collect network traffic information by continuously monitoring network conditions and receiving feedback from individual STAs regarding network metrics, such as SINR, Packet Error Rate (PER), etc. Using the collected data, the AP may evaluate current operating parameters and, where appropriate, compute optimal operating parameters in light of estimated network congestion. The AP may then broadcast a notification to maintain current operating parameters or an alert with a set of “optimal” system operating parameters and instructions that a change is needed using existing signaling, such as action or beacon frames. The STAs may then update their individual parameter values as per the APs instructions.

For STA-centric decision making, each STA may independently determine its own EDCA parameters based on local traffic factor measurements and network conditions, such as PER, SINR, etc. In this instance, each STA may adjust its respective parameter settings locally. When needed, the AP may provide coordination to the STA, including general guidelines or threshold values through beacon or action frames. The STAs may also send operating condition data and optional feedback to the AP through action frames, and may request instructions if the STA needs help from the AP to make network-wide decisions. The AP may then respond with an acknowledgement and recommended parameter updates. For the hybrid AP/STA approach, the AP may provide general network-wide parameter guidelines or thresholds (e.g., max or min allowable values for CWmin, CWmax and other parameters.). Each STA may use these information to make fine-grained adjustments within those bounds based on its own local conditions. This can provide both coordination and flexibility of local adaptation.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a wireless communication system, the method comprising:
monitoring, via a system controller, a plurality of network traffic factors affecting a network congestion of the wireless communication system to generate a raw network traffic data set;
transforming, via the system controller, the raw network traffic data set based on a processing rule set to generate a processed traffic data set;
calculating, using a trained machine-learning (ML) model, a congestion score as a function of traffic factor values within the processed traffic data set each weighted using a respective weight factor assigned to a corresponding traffic factor within the network traffic factors;
determining, via the system controller, if the congestion score exceeds a congestion threshold value; and
modulating, via the system controller responsive to determining the congestion score exceeds the congestion threshold value, operation of the wireless communication system by adjusting a plurality of system WiFi parameters based on the congestion score.

2. The method of claim 1, wherein the congestion score is calculated as Sᵥₜ:
$${S}_{t} = {\sum }_{i = 1}^{I} {w}_{i} {f}_{i}$$
where fᵢ is an i^{th} traffic factor value of the traffic factor values, and wᵢ is the respective weight factor assigned to the corresponding traffic factor of the i^{th} traffic factor value.

3. The method of claim 1, further comprising:
monitoring, via the system controller after adjusting the system WiFi parameters, the network traffic factors to generate a new raw network traffic data set;
transforming, via the system controller, the new raw network traffic data set based on the processing rule set to generate a new processed traffic data set; and
calculating a new congestion score as the function of new traffic factor values within the new processed traffic data set weighted using the respective weight factors.

4. The method of claim 3, further comprising:
determining if the new congestion score exceeds the congestion score; and
setting, via the system controller responsive to the new congestion score exceeding the congestion score, the system WiFi parameters to a set of system-calibrated default WiFi settings.

5. The method of claim 1, further comprising retrieving a set of system-calibrated maximum and minimum (max/min) WiFi parameter values, wherein adjusting the system WiFi parameters is limited by the set of system-calibrated max/min WiFi parameter values.

6. The method of claim 1, wherein the congestion threshold value is a moderate-congestion threshold value, and wherein modulating operation of the wireless communication system includes adjusting the system WiFi parameters to a set of moderate congestion parameter values configured to prioritize select data transmission types for the wireless communication system.

7. The method of claim 6, further comprising:
determining, via the system controller, if the congestion score exceeds a high-congestion threshold value greater than the moderate-congestion threshold value; and
modulating, via the system controller responsive to determining the congestion score exceeds the high-congestion threshold value, operation of the wireless communication system by adjusting the system WiFi parameters to a set of high-congestion parameter values configured to significantly limit preselected data transmission types for the wireless communication system.

8. The method of claim 1, wherein adjusting the system WiFi parameters includes:
increasing respective parameter values for a set of Enhanced Distributed Channel Access (EDCA) parameters and thereby prioritize select types of data packets received by the wireless communication system;
raising a packet detection (PD) threshold value and thereby delimit a signal level at which the wireless communication system demodulates and decodes data packets; and/or
raising an energy detection (ED) threshold value and thereby delimit a noise level at which the wireless communication system detects a radio-frequency (RF) transmission.

9. The method of claim 1, further comprising:
determining, via the system controller, when the congestion score does not exceed the congestion threshold value; and
modulating, via the system controller responsive to determining the congestion score does not exceed the congestion threshold value, operation of the wireless communication system by setting the system WiFi parameters to a set of system-calibrated default WiFi settings.

10. The method of claim 9, further comprising lowering a packet detection (PD) threshold value and/or an energy detection (ED) threshold value of the wireless communication system in response to determining the congestion score does not exceed the congestion threshold value.

11. The method of claim 1, wherein monitoring the network traffic factors includes the system controller communicating through a WiFi network module and/or a software-defined networking (SDN) device with a WiFi driver and/or a WiFi application program interface (API) to measure one or more of the network traffic factors in real-time.

12. The method of claim 1, wherein transforming the raw network traffic data set includes aggregating, averaging, smoothing, and/or finding a min, max, or mean deviation value of raw data in the raw network traffic data set within a specified time window.

13. A non-transient, computer-readable medium storing instructions executable by a system controller of a wireless communication system, the instructions, when executed, causing the system controller to perform operations comprising:
monitoring multiple network traffic factors affecting a network congestion of the wireless communication system to generate a raw network traffic data set;
transforming the raw network traffic data set based on a processing rule set to generate a processed traffic data set;
calculating, using a trained machine-learning (ML) model, a congestion score as a function of multiple traffic factor values within the processed traffic data set each weighted using a respective weight factor assigned to a corresponding traffic factor within the network traffic factors;
determining if the congestion score exceeds a congestion threshold value; and
modulating, responsive to determining the congestion score exceeds the congestion threshold value, operation of the wireless communication system by adjusting multiple system WiFi parameters based on the congestion score.

14. A motor vehicle, comprising:
a vehicle body;
a plurality of road wheels attached to the vehicle body;
a prime mover attached to the vehicle body and configured to drive one or more of the road wheels to thereby propel the motor vehicle;
a wireless communication system attached to the vehicle body and configured to wirelessly exchange data packets with a remote distributed computing system; and
a system controller attached to the vehicle body and programmed to:
monitor multiple network traffic factors affecting a network congestion of the wireless communication system to generate a raw network traffic data set;
transform the raw network traffic data set based on a processing rule set to generate a processed traffic data set;
calculate, using a trained machine-learning (ML) model, a congestion score as a function of multiple traffic factor values within the processed traffic data set each weighted using a respective weight factor assigned to a corresponding traffic factor within the network traffic factors;
determine when the congestion score exceeds a congestion threshold value; and
responsive to determining the congestion score exceeds the congestion threshold value, modulate operation of the wireless communication system by adjusting multiple system WiFi parameters based on the congestion score.

15. The motor vehicle of claim 14, wherein the congestion score is calculated as Sᵥₜ:
$${S}_{t} = {\sum }_{i = 1}^{I} {w}_{i} {f}_{i}$$
where fᵢ is an i^{th} traffic factor value of the traffic factor values, and wᵢ is the respective weight factor assigned to the corresponding traffic factor of the i^{th} traffic factor value.

16. The motor vehicle of claim 14, wherein the system controller is further programmed to:
after adjusting the system WiFi parameters, monitor the network traffic factors to generate a new raw network traffic data set;
transform, using the trained ML model, the new raw network traffic data set based on the processing rule set to generate a new processed traffic data set; and
calculate a new congestion score as the function of new traffic factor values within the new processed traffic data set weighted using the respective weight factors.

17. The motor vehicle of claim 16, wherein the system controller is further programmed to:
determine if the new congestion score exceeds the congestion score; and
responsive to the new congestion score exceeding the congestion score, set the system WiFi parameters to a set of system-calibrated default WiFi settings.

18. The motor vehicle of claim 14, wherein the congestion threshold value is a moderate congestion threshold value, and wherein modulating operation of the wireless communication system includes adjusting the system WiFi parameters to a set of moderate congestion parameter values configured to prioritize select types of data transmissions to the wireless communication system.

19. The motor vehicle of claim 18, wherein the system controller is further programmed to:
determine when the congestion score exceeds a high congestion threshold value greater than the congestion threshold value; and
responsive to determining the congestion score exceeds the high congestion threshold value, modulate operation of the wireless communication system by adjusting the system WiFi parameters to a set of high congestion parameter values configured to significantly limit preselected types of data transmissions to the wireless communication system.

20. The motor vehicle of claim 15, wherein adjusting the system WiFi parameters includes:
increasing parameter values for a set of Enhanced Distributed Channel Access (EDCA) parameters prioritizing select types of data packets received by the wireless communication system;
raising a packet detection (PD) threshold delimiting a signal level at which the wireless communication system demodulates and decodes data packets; and/or
raising an energy detection (ED) threshold delimiting a noise level at which the wireless communication system detects a radio-frequency (RF) transmission.
